(19) United States
(12) Patent Application Publication
(10) Pub. No.: US 2023/0162466 A1
(43) Pub. Date: May 25, 2023

(54) METHOD AND COMPUTER SYSTEM FOR DISPLAYING IDENTIFICATION RESULT

(71) Applicant: Hangzhou Glority Software Limited, Hangzhou (CN)

(72) Inventors: Qingsong Xu, Hangzhou (CN); Qing Li, Hangzhou (CN)

(73) Assignee: Hangzhou Glority Software Limited, Hangzhou (CN)

(21) Appl. No.: 17/772,148

(22) PCT Filed: Oct. 14, 2021
(86) PCT No.: PCT/CN2021/123714

§ 371 Date: Apr. 27, 2022

(30) Foreign Application Priority Data
Nov. 13, 2020 (CN) 202011271432.8

(51) Int. Cl. G06V 10/25; G06V 10/44; G06V 10/22

(52) U.S. Cl. CPC G06V 10/25; G06V 10/44; G06V 10/225

(57) ABSTRACT

The disclosure relates to a method for displaying an identification result, including: receiving an image capable of presenting at least a portion of an object to be identified and identifying at least a portion of the object to be identified presented by the image; and displaying a first picture presenting an identification result in response to obtaining the identification result, where the first picture includes marks targeting a portion or a plurality of portions of the identification result. The disclosure also relates to a computer system for displaying an identification result.

### TECHNICAL FIELD

The disclosure relates to the field of computer technology, and in particular, to a method and a computer system for displaying an identification result.

### DESCRIPTION OF RELATED ART

In the field of computer technology, a variety of applications (APPs) for identifying objects to be identified are available, such as applications for identifying plants. These applications usually receive images from users (including static images, dynamic images, videos, etc.), and identify the objects to be identified in the images based on the identification model established by artificial intelligence technology to obtain identification results. For instance, the identification result obtained when the object is a living creature may be its species. The image from the user usually includes at least a portion of the object to be identified, for example, the image photographed by the user includes stems, leaves, and flowers of the plant to be identified. The identification result may completely match or match to a high degree with the object to be identified in the image, or may have a low degree of matching with the object to be identified in the image. The identification results are usually displayed in the form of pictures.

### SUMMARY

The disclosure aims to provide a method and a computer system for displaying an identification result.

According to the first aspect of the disclosure, the disclosure provides a method for displaying an identification result, and the method includes the following steps. An image capable of presenting at least a portion of an object to be identified is received, and at least a portion of the object to be identified presented by the image is identified. In response to obtaining an identification result, a first picture presenting the identification result is displayed. The first picture includes marks targeting a portion or a plurality of portions of the identification result.

According to the second aspect of the disclosure, the disclosure provides a method for displaying an identification result, and the method includes the following steps. An image capable of presenting at least a portion of an object to be identified is received, and at least a portion of the object to be identified presented by the image is identified. In response to obtaining an identification result, a fifth picture or a plurality of fifth pictures related to the identification result are displayed, and each of the fifth pictures corresponds to a portion of the identification result.

According to the third aspect of the disclosure, the disclosure provides a method for displaying an identification result, and the method includes the following steps. An image capable of presenting a first portion of an object to be identified is received, and the first portion is identified. In response to obtaining an identification result, an eighth picture presenting a first portion of the identification result is displayed. The eighth picture further presents a second portion of the identification result that is different from the first portion.

According to the fourth aspect of the disclosure, the disclosure provides a computer system for displaying an identification result, and the computer system includes a processor or a plurality of processors and a memory or a plurality of memories. The memory or the plurality of memories are configured to store a series of computer-executable instructions and computer-accessible data associated with the series of computer-executable instructions. When the series of computer-executable instructions are executed by the processor or the plurality of processors, the processor or the plurality of processors are enabled to perform the abovementioned method.

According to the fifth aspect of the disclosure, the disclosure provides a non-transitory computer readable storage medium. The non-transitory computer readable storage medium stores a series of computer-executable instructions, and when the series of computer-executable instructions are executed by a computer apparatus or a plurality of computer apparatuses, the computer apparatus or the plurality of computer apparatuses are enabled to perform the abovementioned method.

Other features of the disclosure and advantages thereof will become apparent from the following detailed description of exemplary embodiments of the disclosure with reference to the accompanying drawings.

### BRIEF DESCRIPTION OF THE DRAWINGS

The accompanying drawings, which form a part of the specification, illustrate embodiments of the disclosure and together with the description serve to explain the principles of the disclosure.

The disclosure may be more clearly understood from the following detailed description with reference to the accompanying drawings described as follows.

FIG. 1 is a flow chart schematically illustrating at least a part of a method for displaying an identification result according to an embodiment of the disclosure.

FIG. 2 is a flow chart schematically illustrating at least a part of a method for displaying an identification result according to another embodiment of the disclosure.

FIG. 3 is a flow chart schematically illustrating at least a part of a method for displaying an identification result according to still another embodiment of the disclosure.

FIG. 4A to FIG. 4C are schematic pictures schematically illustrating display screens of a method according to an embodiment of the disclosure.

FIG. 5A to FIG. 5I are schematic pictures schematically illustrating display screens of a method according to another embodiment of the disclosure.

FIG. 6A to FIG. 6C are schematic pictures schematically illustrating display screens of a method according to still another embodiment of the disclosure.

FIG. 7 is a view schematically illustrating a structure of at least a portion of a computer system for displaying an identification result according to an embodiment of the disclosure.

FIG. 8 is a view schematically illustrating a structure of at least a portion of a computer system for displaying an identification result according to another embodiment of the disclosure.

Note that in the embodiments described below, the same reference numerals are used in common between different figures to denote the same parts or parts having the same function, and repeated description thereof is omitted. In this specification, similar numbers and letters are used to denote similar items, and therefore, once an item is defined in one figure, it does not require further discussion in subsequent figures.

### DESCRIPTION OF THE EMBODIMENTS

Various exemplary embodiments of the disclosure are described in detail below with reference to the accompanying drawings. It should be noted that the relative arrangement of the components and steps, the numerical expressions and numerical values set forth in these embodiments do not limit the scope of the disclosure unless specifically stated otherwise. In the following description, in order to better explain the disclosure, numerous details are set forth, however it will be understood that the disclosure may be practiced without these details.

The following description of at least one exemplary embodiment is merely illustrative in nature and is in no way intended to limit the disclosure, its application or uses in any way. In all examples shown and discussed herein, any specific value should be construed as illustrative only and not as limiting.

Techniques, methods, and apparatuses known to a person having ordinary skill in the art may not be discussed in detail, but where appropriate, such techniques, methods, and apparatuses should be considered part of the specification.

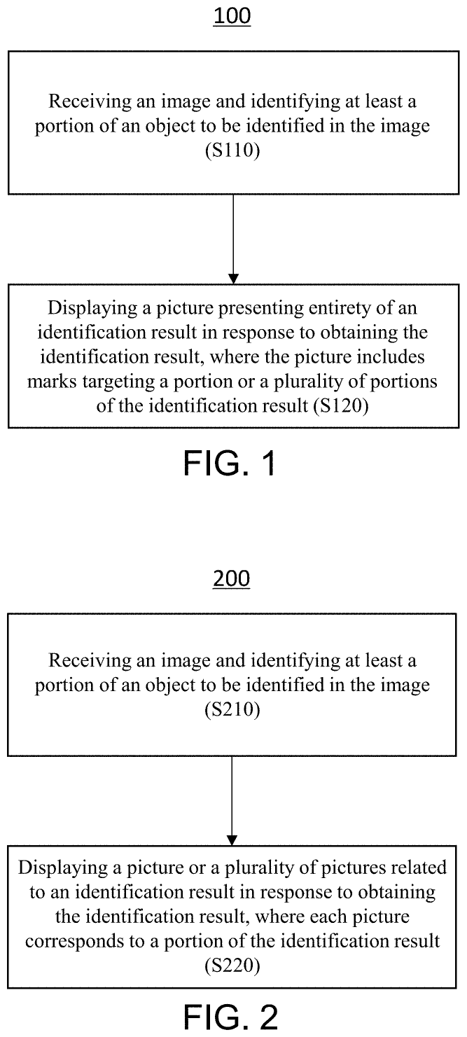

FIG. 1 is a flow chart schematically illustrating at least a part of a method 100 for displaying an identification result according to an embodiment of the disclosure. In the method 100, the following steps are included: an image capable of presenting at least a portion of an object to be identified is received, and at least a portion of the object to be identified presented by the image is identified (step S110). Further, a picture presenting an identification result is displayed in response to obtaining the identification result, where the picture includes a mark or a plurality of marks targeting the identification result (step S120).

In some cases, a user inputs an image of all or a portion of an object to be identified into an application capable of performing object identification in order to obtain information about the object to be identified. For instance, when the object to be identified is a plant, the image may include any one or a combination of any one of the roots, stems, leaves, flowers, fruit, and seeds of the plant to be identified, and each of these items may be the entirety or a portion of such an item. The image may be previously stored by the user, photographed in real time, or downloaded from the Internet. The image may include any form of visual presentation, such as a static image, a dynamic image, and a video. The image may be captured using an apparatus including a camera, such as a mobile phone, a tablet computer, etc. The object to be identified may also be any other object except plants, such as an animal, a mineral, fungi, and the like.

An application capable of implementing the method 100 may receive the image from the user and perform object identification based on the image. Identification may include any known method of image-based object identification. For instance, an object to be identified in an image may be identified by a computing apparatus and a pre-trained (or “trained”) object identification model to obtain an identification result (e.g., a species). An identification model may be established based on a neural network (e.g., a deep convolutional neural network (CNN) or a deep residual network (Resnet), etc.). For instance, a certain number of image samples labeled with the species name of the plant are obtained for each plant species, that is, a training sample set. These image samples are used to train the neural network until the output accuracy of the neural network meets the requirements. The image may also be preprocessed before object identification based on the image. Preprocessing may include normalization, brightness adjustment, or noise reduction, and so on. Noise reduction processing may highlight the description of the characteristics in the image and make the characteristics more distinct.

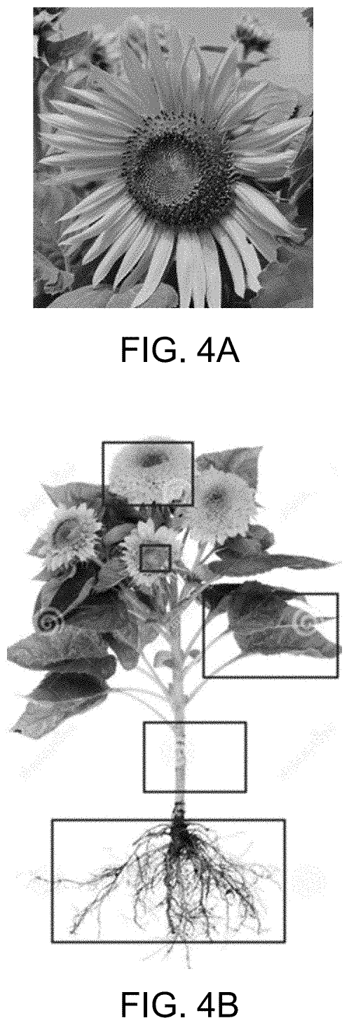

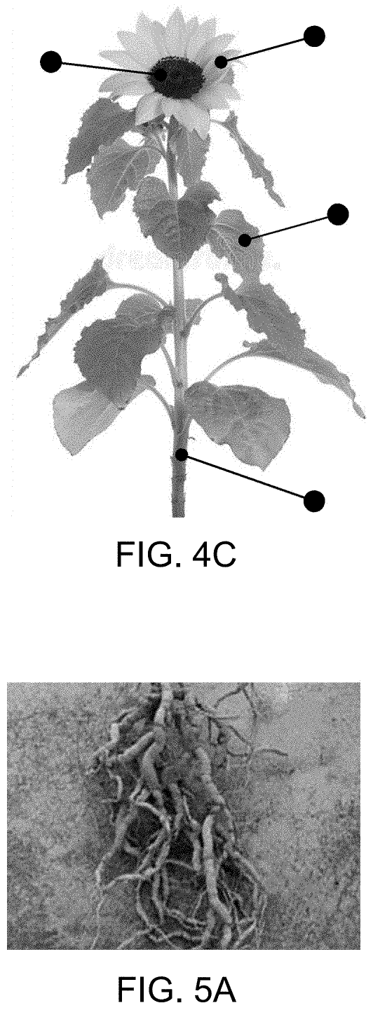

In a specific example, the received image may be as shown in FIG. 4A, where the image presents sunflower flowers, where the object to be identified is a sunflower, and at least a part of which includes flowers (which may also be understood as including leaves as the background of the image). In some cases, an identification result with a high degree of matching with the object to be identified may be obtained, for example, the identification result may be a sunflower. The object identification model may also output a result score corresponding to the identification result to reflect the degree of matching between the identification result and the object to be identified. Thresholds may be set to determine the degree of matching. For instance, when the degree of matching is greater than a first threshold, it may be determined that the degree of matching is high, and when the degree of matching is less than a second threshold, it may be determined that the degree of matching is low. The first threshold and the second threshold may be set according to needs, which may be the same or different. In an embodiment, the displayed pictures presenting the identification result may be as shown in FIG. 4B, which are pictures presenting entirety of the identification result (e.g., the first picture and the sixth picture in the claims may be implemented as such pictures). It should be noted that when the object is a plant, the entirety of the identification result means that the whole plant may be roughly presented, and all portions of the plant are not necessarily required to be included.

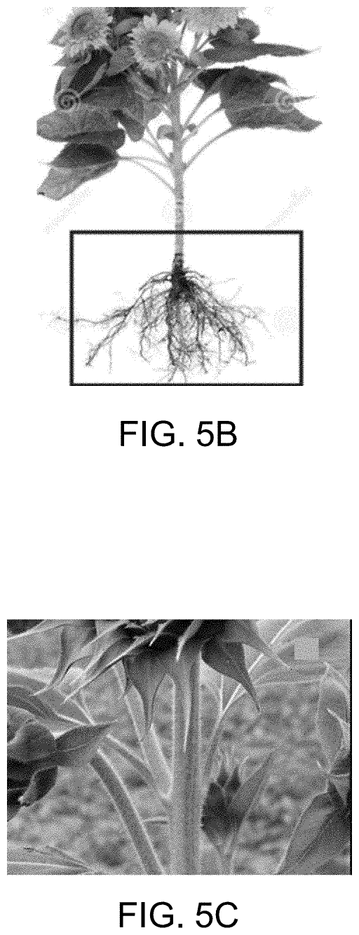

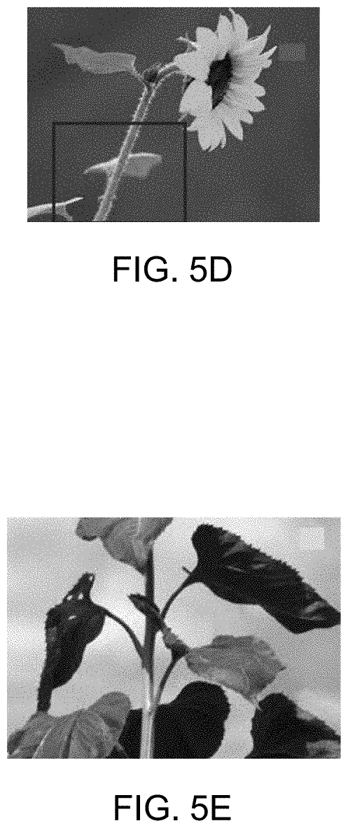

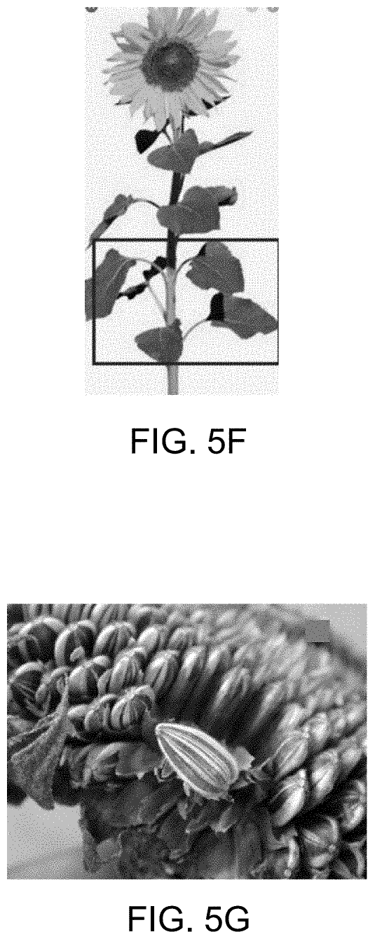

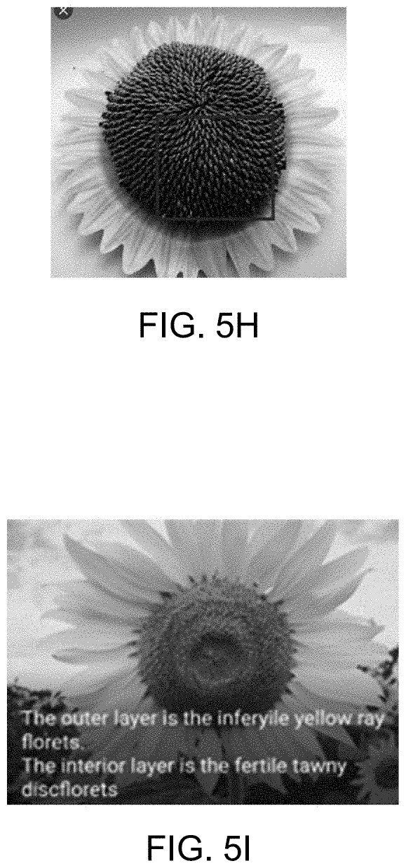

In an embodiment, the displayed pictures presenting the identification result may be as shown in FIG. 4C, which are pictures presenting a portion or a plurality of portions of the identification result (e.g., the first picture and the sixth picture in the claims may also be implemented as such pictures), but it is not required to be a picture presenting the entirety of the identification result. A portion or a plurality of portions of the presented identification result may or may not include a portion corresponding to at least one portion of the object to be identified, and may or may not include portions other than the portion corresponding to the at least one portion of the object to be identified. In an example, in the case where the received image is as shown in FIG. 4A, the displayed picture as shown in FIG. 4C includes the portion corresponding to the flower of the sunflower in the image, and also includes the portions of the sunflower other than the flower. It should be understood that in other examples, the displayed picture may only include a portion corresponding to at least one portion of the object to be identified, i.e., only include the sunflower flower. In another example, the received image may be as shown in FIG. 5A, and the scene may be that the user sees the root of a plant and wants to know which plant the root comes from, or wants to know the characteristics of the root, the characteristics of the plant to which the root belongs, and so on. In this case, the displayed picture as shown in FIG. 4C does not include the portion corresponding to the root in the image, but only includes one or more portions of the sunflower other than the root. It should be understood that in other examples, when the received image is as shown in FIG. 5A, the displayed picture may also be as shown in FIG. 4B, that is, a picture presenting the entirety of the identification result.

The picture shown in FIG. 4B includes marks for a portion or a plurality of portions of the identification result. In this specific example, the mark is a region mark, which is presented by enclosing a region with a rectangular frame in the figure. In the picture shown in FIG. 4B, the regions corresponding to multiple portions of the sunflower, such as the flower, fruit, leaves, stem, and roots, are respectively marked with the rectangular frames. The picture shown in FIG. 4C includes marks for a portion or a plurality of portions of the identification result. In this specific example, the marks are lead marks, and the corresponding portions of the identification result is marked with lead lines in the figure for presentation, for example, a plurality of portions such as the sunflower flower, fruit, leaves, and stem are marked by lead lines. It should be understood that the marks are not limited to the forms enumerated in FIGS. 4B and 4C, as long as the marks may be used to mark one or more portions of the identification result presented in the picture. For instance, in addition to the region and line marks, the marks may also be text, symbols, picture marks, or a combination of any of these types of marks. The marks included in the picture targeting a portion or a plurality of portions of the identification result may be marked according to the picture in advance and stored in association with the picture, or the marks may also be identified and marked on the picture by a pre-trained region identification model (or a target detection model and the like) after the picture of the identification result is obtained.

The mark or the portion targeted by the mark may be manipulated. The operation may include clicking, double-clicking, touching, pressing, stretching and zooming, sliding, etc. For instance, the user may click on the region framed by the rectangular frame as shown in FIG. 4B or click on the rectangular frame itself, or click on the lead lines (e.g., the ends of the lead lines) as shown in FIG. 4C or the portions pointed by the lead lines. In an embodiment, in response to the marks or the portions targeted by the mark being operated, pictures (e.g., the second picture, fifth picture, and ninth picture in the claims may be implemented as such pictures) and/or associated text presenting the portions of the identification result targeted by the marks are displayed. The pictures may be pictures presenting the details of the corresponding portions of the identification result, as shown in FIGS. 5A, 5C, 5E, and 5G, and/or may be pictures presenting positions of the corresponding portions of the identification result in the identification result, as shown in FIGS. 5B, 5D, 5F, and 5H. In addition, in response to the above operation, text related to the pictures may also be displayed in association with the pictures, as shown in FIG. 5I. It should be understood that in response to the above operation, instead of displaying the pictures, only text related to the portions of the identification result targeted by the marks, such as characteristics such as the shapes of the portions and description of how to identify these portions, may be displayed. For instance, the user may be interested in the sunflower fruit after inputting the image shown in FIG. 4A and viewing the identification result shown in FIG. 4B. The user can click on the fruit region as shown in FIG. 4B, and the application executing the method 100 may display the picture as shown in FIG. 5G or 5H to the user, so that the user may further understand the details of the sunflower fruit. In pictures presenting the positions of the corresponding portions of the identification result in the identification result as shown in FIGS. 5B, 5D, 5F, and 5H, if the user wants to view the detailed characteristics of one portion, the user may manipulate the region where this portion is located in the picture, and the application executing the method 100 may display to the user a picture presenting the details of the portion and/or text describing the characteristics of the portion.

In an embodiment, in response to the mark or the portion targeted by the mark being operated, information related to an object having a characteristic of the portion of the identification result targeted by the mark is displayed. For instance, after the identification result as shown in FIG. 4B is displayed, the user may want to know the information of objects having some of the same characteristics as the identification result. Alternatively, the user may feel that the identification result is inaccurate or is not as expected. The user may then select one or more portions of the identification result that are more closely matched to the object to be identified. In this way, the application performing the method 100 may display objects that have only the characteristics of the portions selected by the user (while ignoring those portions of the identification result that have a low degree of matching with the object to be identified), so that the user may find results from these displayed objects that the user considers accurate or as expected. In these cases, the user may select one or more of the marks presented in FIG. 4B or the portions to targeted by the marks, such as selecting the marks corresponding to the roots, stem, and leaves. The application executing the method 100 may select all objects in a database that have the same characteristics as those of the portions corresponding to these marks and displays the relevant information (text and/or pictures) of these objects to the user.

The “selection” described here is operation performed by the user. The application executing the method 100 may allow the user to perform positive selection, that is, to select one or more characteristics of the portion to be retained through operation such as clicking and may also allow the user to perform negative selection, that is, delete one or more characteristics of the portions that the user wants to ignore through operation such as clicking.

A characteristic usually refers to the shape of a specific portion of the object or the identification result. For instance, when the portion is a leaf of a plant, the shape characteristic of the leaf may include heart shape, kidney shape, egg shape, oval shape, triangle shape, circle shape, fan shape, sword shape, oblong shape, needle shape, bar shape, diamond shape, and the like. It should be understood that the leaf portion of the plant may also have other categories of characteristics, such as texture characteristics, edge characteristics (smooth or burrs), solitary/opposite characteristics, and the like. In the database, classification may be performed according to each shape characteristic of leaves, that is, the species of plants with this characteristic are stored under the classification of each shape characteristic. Correspondingly, for each characteristic of each portion including the roots, stem, leaves, flowers, fruit, and seeds, the species of the object whose portions have the characteristics may be stored under the characteristic classification (including the name of the species, pictures, text introduction, etc.). According to each characteristic possessed by the portion of the identification result selected by the user, the common species (i.e., the intersection of the species stored under these characteristic classifications) under the classification of these characteristics is selected, that is, the output result that may be displayed when the application of the method 100 is executed in the embodiment.

In an embodiment, in response to obtaining the identification result, pictures (e.g., the third picture and the seventh picture in the claims may be implemented as such pictures) corresponding to the image are also displayed, for example, the received image itself, a partial picture of the image, a thumbnail image of the image, and the like. In an embodiment, it is difficult for the object identification model to obtain an identification result whose degree of matching with the object to be identified meets the requirements based on the received image, that is, no identification result is obtained. In response to no identification result being obtained, the application performing the method 100 may display one or more pictures of one or more objects similar to the object to be identified (e.g., the fourth picture in the claims may be implemented as such a picture). For instance, pictures of other species that are similar to sunflowers may be outputted when one or more portions of a sunflower are included in the image but not identified. For another instance, if the image includes multiple portions of a plant, and it is difficult to find an identification result that matches all the portions, an identification result that matches only some portions may be outputted.

FIG. 2 is a flow chart schematically illustrating at least a part of a method 200 for displaying an identification result according to an embodiment of the disclosure. In the method 200, the following steps are included: an image capable of presenting at least a portion of an object to be identified is received, and at least a portion of the object to be identified presented by the image is identified (step S210). Further, in response to obtaining an identification result, a picture or a plurality of pictures related to the identification result are displayed, where each of the pictures corresponds to a portion of the identification result (step S220). In a specific example, a user may input an image as shown in FIG. 4A. After the identification result is obtained by an application executing the method 200, pictures corresponding to the portions of the identification result as shown in FIGS. 5A, 5C, 5E, and 5G (or FIGS. 5B, 5D, 5F, and 5H) may be displayed to the user (not an entire picture or a picture including a plurality of portions as described in the above embodiments as shown in FIG. 4B or 4C). The user may manipulate these pictures, and in response to the pictures being operated, the application performing the method 200 may highlight the pictures and/or text associated with the pictures to allow the user to learn more about the portions of the identification result. This display method may be applied in a situation where the identification result obtained by the object identification model has a high degree of matching with the object to be identified, or may be applied in a situation where the degree of matching is low.

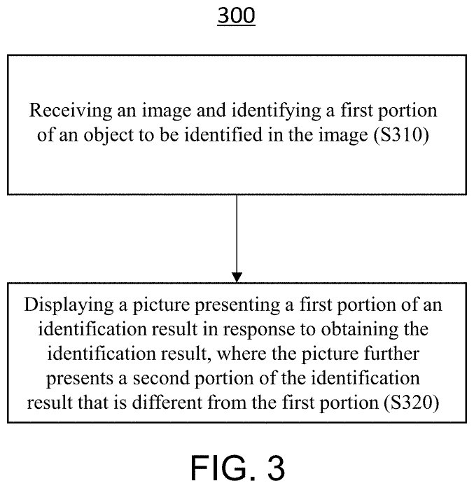

FIG. 3 is a flow chart schematically illustrating at least a part of a method 300 for displaying an identification result according to an embodiment of the disclosure. In the method 300, the following steps are included: an image capable of presenting a first portion of an object to be identified is received, and the first portion is identified (step S310). Further, in response to obtaining an identification result, a picture presenting a first portion of the identification result is displayed, where the picture further presents a second portion of the identification result that is different from the first portion (step S320). Herein, the second portion presented by the picture is manipulatable, and in response to the second portion being manipulated, a picture presenting the second portion and/or text associated with the second portion is displayed. In a specific example, a user may input an image as shown in FIG. 5A (the first portion presented is the roots), and the application executing the method 200 may display the pictures as shown in FIG. 4B or 5B (the roots and at least one other portion except the roots are presented), so that the user may directly understand the characteristics of the other portions other than the roots outputted by the user himself/herself.

In other embodiments, there may be situations where the identification result does not match one or more portions of the object to be identified. In such a case, each portion of the identification result may be outputted, and the degree of matching of each portion may be marked. For instance, when identifying several characteristics of sunflower roots, stem, leaves, flowers, and fruit, the identification results of roots, stem, leaves, and flowers are correct, but the identification result of fruit may be incorrect. The application that executing the above method may automatically mark the correct portion (that is, the portion with a high degree of matching) with √ (acting as an example only, and other words, symbols, or pictures, etc. may also be used for marking). For the portion that is incorrectly identified (that is, the portion with a low degree of matching), this portion may be automatically marked with × (acting as an example only, and other words, symbols, or pictures, etc. may also be used for marking). In another example, the user may be allowed to mark the correctness and incorrectness, or the user may be allowed to modify the correctness and incorrectness of automatic mark provided by the application. Further, according to the marked correct or incorrect portions, the application may display the objects having all the characteristics of the portions that are correctly identified for the user's reference. The user may select the most similar result to the object to be identified from these objects.

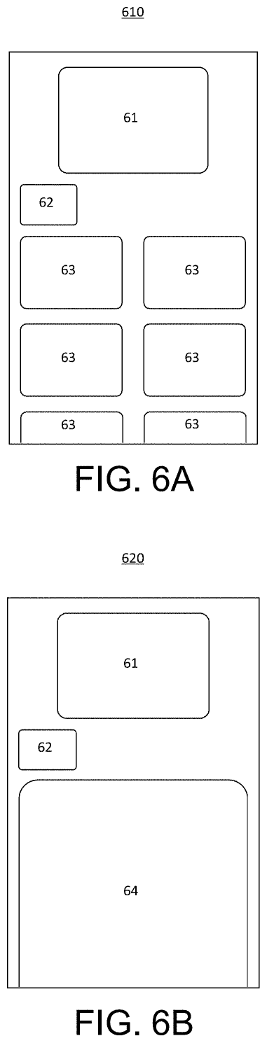

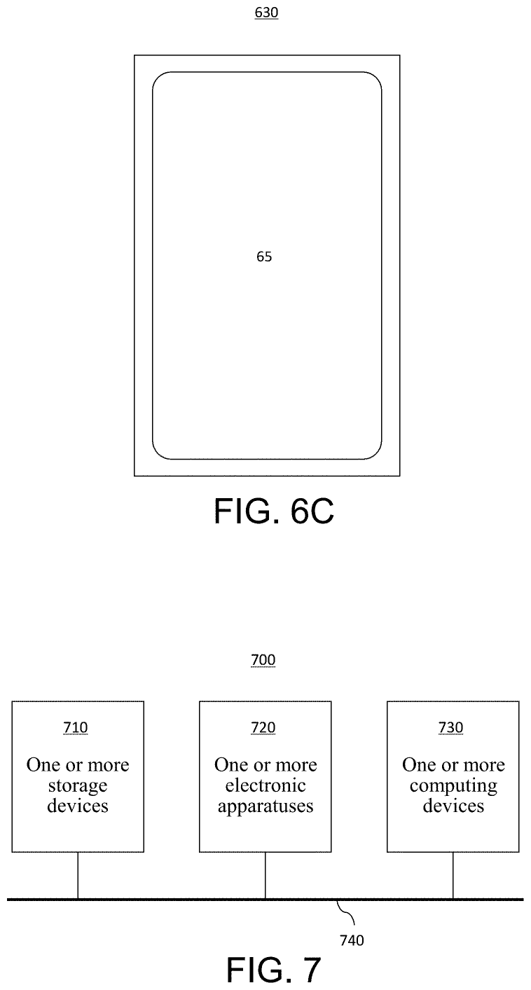

With reference to FIGS. 6A to 6C, a plurality of display screens in the methods 100 to 300 for displaying the identification result according to the abovementioned embodiments of the disclosure are illustrated with specific examples.

An exemplary screen 610 displaying an identification result is shown in FIG. 6A. A region 62 may be configured to display a picture (e.g., all or part of the image) corresponding to the received image as shown in FIG. 4A, a region 61 may be configured to display a picture presenting multiple portions of the identification result as shown in FIG. 4B or 4C (which may or may not include the mark targeting each portion), and a region 63 may be configured to display a picture presenting the details of each portion and/or the position of each portion in the identification result as shown in FIGS. 5A to 5I. If the user is interested in a specific portion and manipulates the region 63 corresponding to that portion, the screen 610 may then be changed to a screen 630 as shown in FIG. 6C to display the information (picture and/or text) of the portion in the foreground of the application or to switch to another page of the application to display the information (picture and/or text) of the portion in the region 65. In a variant example, the screen 610 may not include the region 62. The region 61 may be configured to display a picture corresponding to the received image as shown in FIG. 4A, and the region 63 may be configured to display a picture presenting the details of a portion and/or the position of a portion in the identification result as shown in FIGS. 5A to 5I.

Another exemplary screen 620 displaying the identification result is shown in FIG. 6B. The region 62 may be configured to display a picture corresponding to the received image as shown in FIG. 4A, the region 61 may be configured to display a picture of a portion of the identification result as shown in FIG. 5I corresponding to a portion of the object to be identified in the received image (e.g., the portion of the sunflower flower as in the image), and the region 64 may be configured to display a picture presenting a plurality of portions of the identification result as shown in FIG. 4B or 4C, including the mark targeting each portion. If the user is interested in a specific portion and manipulates the portion or the mark corresponding to that portion, the screen 620 may then be changed to the screen 630 as shown in FIG. 6C to display the information of the portion in the foreground of the application or to switch to another page of the application to display the information of the portion in the region 65. Besides, if the user selects one or more portions of the picture displayed in the region 64 or one or more marks corresponding to the one or more portions, the screen 620 may then be changed to the screen 610 as shown in FIG. 6A. Herein, the region 63 is configured to display information related to objects having the same characteristics as those of the portions corresponding to these marks. Similar to the above, the region 62 is optional. In a variant example, the screen 620 may not include the region 62. The region 61 may be configured to display a picture corresponding to the received image as shown in FIG. 4A, and the region 64 may be configured to display a picture presenting multiple portions of the identification result as shown in FIG. 4B or 4C, including the mark targeting each portion.

The picture corresponding to the received image may not be displayed on the screen, but only the identification result may be displayed. Another exemplary screen 630 displaying the identification results is shown in FIG. 6C. The region 65 may be configured to display a picture presenting multiple portions of the identification result as shown in FIG. 4B or 4C, including the mark targeting each portion. If the user is interested in a specific portion and manipulates the portion or the mark corresponding to that portion, the region 65 of the screen 630 may then be changed to display the information of the portion. Besides, if the user selects one or more portions of the picture displayed in the region 65 or one or more marks corresponding to the one or more portions, in an example, the screen 630 may then be changed to the screen 610 as shown in FIG. 6A. Herein, the region 63 is configured to display information related to objects having the same characteristics as those of the portions corresponding to these marks. In another example, the screen 630 may be changed to display the information related to each of these objects in the region 65. For instance, the region 65 may display one such object first, and the user may swipe up or down or left and right to view more objects. In addition, for the above-described embodiments, when a plurality of pictures related to various portions of the identification result are displayed in response to obtaining the identification result, the screen 630 may also be used for displaying. For instance, the region 65 may display one such picture (and/or text) first, which corresponds to a portion of the identification result, and the user may view pictures corresponding to more portions by swiping up and down or left and right.

It should be understood that the pictures in any of the above regions 61 to 65 may be appended with text description, for example, may be displayed in the form shown in FIG. 5I. The text may include the name of the species, characteristics, growth habits, how to conserve the species, a detailed introduction to a specific part, and how to identify the species. In addition, the screens 610 to 630 described above in together with FIGS. 6A to 6C are only exemplary to explain the method for displaying the identification result according to the embodiments of the disclosure, and cannot be used to limit the disclosure. In the screen 610, when the multiple regions 63 are all used for displaying pictures, the disclosure does not limit the arrangement order of the respective pictures. For instance, the pictures may be sorted according to the degree of similarity/matching between the pictures and the object to be identified, and the more similar/matching is arranged at the front. Sorting may also be performed according to the degree of association between the pictures and the object to be identified. For instance, when the object to be identified presented in the image is a whole, the whole picture may be arranged in the front when outputting and displaying. However, when the object to be identified presented in the image is the stem and leaves of a plant, the pictures showing the stem and/or leaves of the plant may be arranged in the front.

Various pictures involved in the embodiments of the disclosure, such as the picture presenting the entirety of the identification result, the pictures presenting a plurality of portions of the identification result, the detailed picture presenting a portion of the identification result, the picture presenting the position of a portion of the identification result in the identification result, the picture presenting a portion of the identification result corresponding to a portion of the object to be identified in the received image, etc., may all be obtained from the abovementioned training sample set. Usually in the above training sample set, there are multiple samples (usually a large number of samples) for a species. For each species, a sample may be determined in advance as a representative picture of the species. The representative picture is preferably selected when it is necessary to display the entire picture or pictures of multiple portions of the identification result, or when it is necessary to display the picture of a portion of the identification result corresponding to a portion of the object to be identified in the received image. A representative picture may also be determined in advance for each portion of each species, and when a picture of a specific portion of the identification result is required to be displayed, the representative picture is preferentially selected.

FIG. 7 is a view schematically illustrating a structure of at least a portion of a computer system 700 for displaying an identification result according to an embodiment of the disclosure. A person having ordinary skill in the art may understand that the system 700 is merely an example and should not be viewed as limiting the scope of the disclosure or the characteristics described herein. In this example, the system 700 may include a storage device 710 or a plurality of storage devices 710, an electronic apparatus 720 or a plurality of electronic apparatuses 720, and a computing device 730 or a plurality of computing devices 730, which may be communicatively connected to each other through a network or bus 740. The one or plurality of storage devices 710 provide storage services for the one or plurality of electronic apparatuses 720 and the one or plurality of computing devices 730. The one or plurality of storage devices 710 are shown in the system 700 as a separate block from the one or plurality of electronic apparatuses 720 and the one or plurality of computing devices 730, but it should be understood that the one or plurality of storage devices 710 may actually be stored on any of the other entities 720 and 730 included in the system 700. Each of the one or plurality of electronic apparatuses 720 and the one or plurality of computing devices 730 may be located at different nodes of the network or bus 740 and may directly or indirectly communicate with other nodes of the network or bus 740. A person having ordinary skill in the art may understand that the system 700 may further include other devices not shown in FIG. 7, where each different device is located at a different node of the network or bus 740.

The one or plurality of storage devices 710 may be configured to store any of the data described above, including but not limited to: received images, neural network models, individual sample sets/sample libraries, databases recording the characteristics of various plants, application program files, and the like. The one or plurality of computing devices 730 may be configured to perform one or more of the methods 100, 200, and 300, and/or one or more steps of the one or more of the methods 100, 200, and 300. The one or plurality of electronic apparatuses 720 may be configured to provide a service to a user, which may display pictures and screens 610 to 630 as shown in FIGS. 4A to 5I. The one or plurality of electronic apparatuses 720 may also be configured to perform one or more steps of the methods 100, 200, and 300.

The network or bus 740 may be any wired or wireless network and may also include cables. The network or bus 740 may be part of the Internet, the World Wide Web, a specific intranet, a wide area network, or a local area network. The network or bus 740 may utilize standard communication protocols such as Ethernet, WiFi, HTTP, etc., protocols that are proprietary to one or more companies, and various combinations of the foregoing protocols. The network or bus 740 may also include but not limited to an Industry Standard Architecture (ISA) bus, a Micro Channel Architecture (MCA) bus, an Enhanced ISA (EISA) bus, a Video Electronics Standards Association (VESA) local bus, and a Peripheral Component Interconnect (PCI) bus.

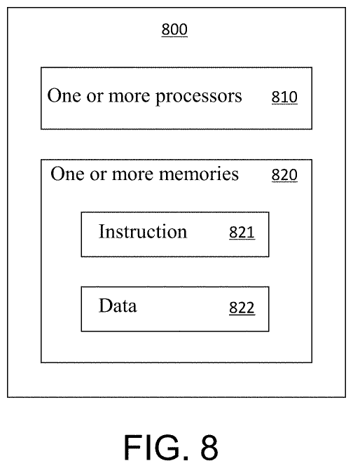

Each of the one or plurality of electronic apparatuses 720 and the one or plurality of computing devices 730 may be configured similarly to a system 800 shown in FIG. 8, i.e., having a processor 810 or a plurality of processors 810, a memory 820 or a plurality of memories 820, instructions, and data. Each of the one or plurality of electronic apparatuses 720 and the one or plurality of computing devices 730 may be a personal computing device intended for use by a user or a business computer device intended for use by an enterprise and may have all of the components typically used together with a personal computing device or a commercial computing device, such as a central processing unit (CPU), a memory (e.g., RAM and internal hard drive) for storing data and instructions, and one or more I/O devices such as a display (e.g., a monitor with a screen, a touch screen, a projector, a television, or other devices operable to display information), a mouse, a keyboard, a touch screen, a microphone, a speaker, and/or a network interface device.

The one or plurality of electronic apparatuses 720 may also include one or more cameras for capturing still images or recording video streams, as well as all components for connecting these elements to each other. The one or plurality of electronic apparatuses 720 may each include a full-sized personal computing device, but they may alternatively include mobile computing devices capable of wirelessly exchanging data with a server over a network such as the Internet. For instance, the one or plurality of electronic apparatuses 720 may be a mobile phone, or a device such as a PDA with wireless support, a tablet PC, or a netbook capable of obtaining information via the Internet. In another example, the one or plurality of electronic apparatuses 720 may be a wearable computing system.

FIG. 8 is a view schematically illustrating a structure of at least a portion of a computer system 800 for displaying an identification result according to an embodiment of the disclosure. The system 800 includes a processor 810 or a plurality of processors 810, a memory 820 or a plurality of memories 820, and other components (not shown) typically found in a computer or the like. Each of the one or plurality of memories 820 may store content accessible by the one or plurality of processors 810, including an instruction 821 that may be executed by the one or plurality of processors 810 and data 822 that may be retrieved, operated, or stored by the one or plurality of processors 810.

The instruction 821 may be any instruction set to be executed directly by the one or plurality of processors 810, such as a machine code, or any instruction set to be executed indirectly, such as a script. The terms “instructions”, “applications”, “processes”, “steps”, and “programs” may be used interchangeably in the specification. The instruction 821 may be stored in an object code format for direct processing by the one or plurality of processors 810 or may be stored as any other computer language, including scripts or collections of independent source code modules that are interpreted on demand or compiled in advance. The instruction 821 may include an instruction that cause, for example, one or plurality of the processors 810 to function as various neural networks in the specification. The functions, methods, and routines of the instruction 821 are explained in detail elsewhere in the specification.

The one or plurality of memories 820 may be any temporary or non-transitory computer readable storage medium capable of storing content accessible by the one or plurality of processors 810, such as a hard drive, a memory card, ROM, RAM, DVD, CD, USB memory, writable memory, read-only memory, and the like. One or more of the one or plurality of memories 820 may include a distributed storage system. The instruction 821 and/or data 822 may be stored on a number of different storage devices that may be physically located in the same or different geographic locations. One or more of the one or plurality of memories 820 may be connected to the one or plurality of processors 810 via a network and/or may be directly connected to or incorporated into any one of the one or plurality of processors 810.

The one or plurality of processors 810 may retrieve, store, or modify data 822 in accordance with the instruction 821. The data 822 stored in the one or plurality of memories 820 may include at least a portion of one or more of the items stored in the one or plurality of storage devices 710 described above. For instance, although the subject matter described in the specification is not limited to any particular data structure, the data 822 may also be stored in a computer register (not shown), in a relational database as a table or XML document with many different fields and records. The data 822 may be formatted in any computing device readable format, such as, but not limited to, binary values, ASCII, or Unicode. In addition, the data 822 may also include any information sufficient to identify relevant information, such as numbers, descriptive text, proprietary codes, pointers, references to data stored in other memory, such as at other network locations, or information used by functions to compute relevant data.

The one or plurality of processors 810 may be any conventional processor, such as a commercially available central processing unit (CPU), a graphics processing unit (GPU), or the like. Alternatively, the one or plurality of processors 810 may also be special-purpose components, such as application specific integrated circuits (ASICs) or other hardware-based processors. Although not required, the one or plurality of processors 810 may include specialized hardware components to perform specific computational processes faster or more efficiently, such as image processing of images and the like.

The one or plurality of processors 810 and the one or plurality of memories 820 are schematically shown in the same box in FIG. 8, but the system 800 may actually include multiple processors or memories that may reside within the same physical housing or within multiple different physical housings. For instance, one of the one or plurality of memories 820 may be a hard drive or other storage medium located in a different housing than the housing of each of the one or more computing devices (not shown) described above. Accordingly, references to a processor, computer, computing device, or memory should be understood to include reference to a collection of processors, computers, computing devices, or memories that may or may not operate in parallel.

The term “A or B” in the specification includes “A and B” and “A or B”, but not exclusively “A” or only “B” unless specifically stated otherwise.

In the disclosure, reference to “one embodiment” or “some embodiments” means that a feature, structure, or characteristic described in connection with the embodiment is included in at least one embodiment and at least some embodiments of the disclosure. Therefore, presence of the phrases “in one embodiment” and “in some embodiments” in various places in the disclosure are not necessarily referring to the same embodiment or embodiments. Besides, the characteristics, structures, or features may be combined in any suitable combination and/or sub-combination in one or more embodiments.

As used herein, the word “exemplary” means “serving as an example, instance, or illustration” rather than as a “model” to be exactly reproduced. Any implementation illustratively described herein is not necessarily to be construed as preferred or advantageous over other implementations. Further, the disclosure is not to be bound by any expressed or implied theory presented in the preceding technical field, background, summary, or specific embodiments.

In addition, specific terms may also be used in the following description for reference purposes only, and are thus not intended to be limiting. For instance, the terms “first”, “second”, and other such numerical terms referring to structures or elements do not imply a sequence or order unless the context clearly indicates otherwise. It should also be understood that the term “including/comprising” when used in the specification indicates the presence of the indicated feature, integer, step, operation, unit, and/or component, but does not exclude the presence or addition of one or more other features, integers, steps, operations, units and/or components, and/or combinations thereof.

In the disclosure, the terms “component” and “system” are intended to refer to a computer-related entity, hardware, a combination of hardware and software, software, or software in execution. For instance, a component may be but not limited to a process, an object, an executable state, a thread of execution, and/or a program, etc. running on a processor. By way of examples, both an application running on a server and the server may be one component. The one or more components may reside within an executing process and/or thread, and a component may be localized on one computer and/or distributed between two or more computers.

A person having ordinary skill in the art may know that the boundaries between the operations described above are merely illustrative. Multiple operations may be combined into a single operation, a single operation may be distributed among additional operations, and operations may be performed at least partially overlapping in time. Further, alternative embodiments may include multiple instances of a particular operation, and the order of operations may be changed in other various embodiments. However, other modifications, changes, and substitutions are equally possible. Therefore, the specification and drawings are to be regarded in an illustrative rather than a restrictive sense.

In addition, the embodiments of the disclosure may also include the following examples.

1. A method for displaying an identification result, including:

receiving an image capable of presenting at least a portion of an object to be identified and identifying at least a portion of the object to be identified presented by the image; and

displaying a first picture presenting an identification result in response to obtaining the identification result, where the first picture includes one or a plurality of marks targeting one or a plurality of portions of the identification result.

2. The method according to 1, further including:

displaying a second picture and/or associated text presenting the portion of the identification result targeted by the mark in response to the mark or the portion targeted by the mark being operated.

3. The method according to 1, further including:

displaying information related to an object having a characteristic of the portion of the identification result targeted by the mark in response to the mark or the portion targeted by the mark being operated.

4. The method according to 1, where: the first picture is a picture presenting entirety of the identification result.

5. The method according to 1, where: the first picture is a picture presenting one or a plurality of portions of the identification result, and the presented one or plurality of portions of the identification result are:

a portion of the identification result corresponding to at least one portion of the object to be identified; and/or

portions of the identification result other than the portion corresponding to the at least one portion of the object to be identified.

6. The method according to 2, where: the second picture is a picture presenting details of a corresponding portion of the identification result and/or a picture presenting a position of the corresponding portion of the identification result in the identification result.

7. The method according to 1, where: the mark includes a combination of one or more of an area mark, a lead mark, a text mark, a symbol mark, and a picture mark.

8. The method according to 1, further including:

further displaying a third picture corresponding to the image in response to obtaining the identification result; and

displaying one or a plurality of fourth pictures of one or a plurality of objects in proximity to the object to be identified in response to no identification result being obtained.

9. A method for displaying an identification result, including:

receiving an image capable of presenting at least a portion of an object to be identified and identifying at least a portion of the object to be identified presented by the image; and

displaying a plurality of fifth pictures related to an identification result in response to obtaining the identification result, where each of the fifth pictures corresponds to a portion of the identification result.

10. The method according to 9, where: the fifth pictures are pictures presenting details of corresponding portions of the identification result and/or pictures presenting positions of the corresponding portions of the identification result in the identification result.

11. The method according to 9, further including: displaying a sixth picture presenting a plurality of portions of the identification result.

12. The method according to 9, further including:

displaying a sixth picture presenting entirety of the identification result in response to obtaining the identification result and a degree of matching between the identification result and the object to be identified being greater than a first threshold, where the sixth picture includes at least one mark targeting at least a portion of the identification result presented in the sixth picture; and

displaying the fifth picture corresponding to the portion of the fifth picture of the identification result targeted by the mark in response to the mark or the portion targeted by the mark being operated.

13. The method according to 12, further including:

further displaying information related to an object having a characteristic of a portion or a plurality of portions of the identification result targeted by a mark or a plurality of marks in response to the mark or the plurality of marks in the at least mark or the portion or the plurality of portions targeted by the mark or the plurality of marks being operated.

14. The method according to 12, where: the mark includes a combination of one or more of an area mark, a lead mark, a text mark, a symbol mark, and a picture mark.

15. The method according to 9, where: displaying the fifth picture in response to obtaining the identification result and a degree of matching between the identification result and the object to be identified being less than a second threshold, where a portion of the identification result corresponding to the fifth picture matches a corresponding portion of the object to be identified.

16. The method according to 9, further including:

displaying text associated with the fifth picture in association with the fifth picture.

17. The method according to 9, further including:

highlighting the fifth pictures and/or text associated with the fifth pictures in response to the fifth pictures being operated.

18. The method according to 9, further including:

further displaying a seventh picture corresponding to the image in response to obtaining the identification result.

19. A method for displaying an identification result, including:

receiving an image capable of presenting a first portion of an object to be identified and identifying the first portion; and

displaying an eighth picture presenting a first portion of an identification result in response to obtaining the identification result, where the eighth picture further presents a second portion of the identification result that is different from the first portion.

20. The method according to 19, where: the second portion presented by the eighth picture is manipulatable, and the method further includes:

displaying a ninth picture presenting the second portion and/or text associated with the second portion in response to the second portion being operated.

21. A computer system for displaying an identification result, including:

a processor or a plurality of processors; and

a memory or a plurality of memories, where the memory or the plurality of memories are configured to store a series of computer-executable instructions and computer-accessible data associated with the series of computer-executable instructions,

where when the series of computer-executable instructions are executed by the processor or the plurality of processors, the processor or the plurality of processors are enabled to perform the method according to any one of 1 to 20.

22. A non-transitory computer readable storage medium, where the non-transitory computer readable storage medium stores a series of computer-executable instructions, and when the series of computer-executable instructions are executed by a computer apparatus or a plurality of computer apparatuses, the computer apparatus or the plurality of computer apparatuses are enabled to perform the method according to any one of 1 to 20.

Although some specific embodiments of the disclosure are described in detail by way of examples, a person having ordinary skill in the art should know that the above examples are provided for illustration only and not for the purpose of limiting the scope of the disclosure. The various embodiments disclosed herein may be combined arbitrarily without departing from the spirit and scope of the disclosure. It will also be understood by a person having ordinary skill in the art that various modifications may be made to the embodiments without departing from the scope and spirit of the disclosure. The scope of the disclosure is defined by the appended claims.

1. A method for displaying an identification result, comprising:
receiving an image, which is capable of presenting at least one portion of an object to be identified, and identifying the at least one portion of the object to be identified presented by the image; and
displaying a first picture presenting the identification result in response to obtaining the identification result, wherein the first picture comprises a mark or a plurality of marks targeting a portion or a plurality of portions of the identification result.

2. The method according to claim 1, further comprising:
displaying a second picture and/or associated text presenting the portion of the identification result targeted by the mark in response to the mark or the portion targeted by the mark being operated.

3. The method according to claim 1, further comprising:
displaying information related to an object having a characteristic of the portion of the identification result targeted by the mark in response to the mark or the portion targeted by the mark being operated.

4. The method according to claim 1, wherein the first picture is a picture presenting entirety of the identification result.

5. The method according to claim 1, wherein the first picture is a picture presenting the portion or the plurality of portions of the identification result, and the portion or the plurality of portions of the identification result, which are presented, are:
a portion of the identification result corresponding to the at least one portion of the object to be identified; and/or
portions of the identification result other than the portion, which is corresponding to the at least one portion of the object to be identified.

6. The method according to claim 2, wherein the second picture is a picture presenting details of corresponding portions of the identification result and/or a picture presenting a position of the corresponding portions of the identification result in the identification result.

7. The method according to claim 1, wherein the mark comprises a combination of one or more of an area mark, a lead mark, a text mark, a symbol mark, and a picture mark.

8. The method according to claim 1, further comprising:
further displaying a third picture corresponding to the image in response to obtaining the identification result; and
displaying one or a plurality of fourth pictures of one or a plurality of objects similar to the object to be identified in response to no identification result being obtained.

9. A method for displaying an identification result, comprising:
receiving an image, which is capable of presenting at least one portion of an object to be identified, and identifying the at least one portion of the object to be identified presented by the image; and
displaying a plurality of fifth pictures related to the identification result in response to obtaining the identification result, wherein each of the fifth pictures corresponds to a portion of the identification result.

10. The method according to claim 9, wherein the fifth pictures are pictures presenting details of corresponding portions of the identification result and/or pictures presenting positions of the corresponding portions of the identification result in the identification result.

11. The method according to claim 9, further comprising: displaying a sixth picture presenting a plurality of portions of the identification result.

12. The method according to claim 9, further comprising:
displaying a sixth picture presenting entirety of the identification result in response to obtaining the identification result and a degree of matching between the identification result and the object to be identified being greater than a first threshold, wherein the sixth picture comprises at least one mark targeting at least one portion of the identification result presented in the sixth picture; and
displaying the fifth picture corresponding to the portion of the identification result targeted by the mark in response to the mark or the portion targeted by the mark being operated.

13. The method according to claim 12, further comprising:
further displaying information related to an object having a characteristic of a portion or a plurality of portions of the identification result targeted by a mark or a plurality of marks in response to the mark or the plurality of marks in the at least one mark or the portion or the plurality of portions targeted by the mark or the plurality of marks being operated.

14. The method according to claim 12, wherein the mark comprises a combination of one or more of an area mark, a lead mark, a text mark, a symbol mark, and a picture mark.

15. The method according to claim 9, wherein displaying the fifth picture in response to obtaining the identification result and a degree of matching between the identification result and the object to be identified being less than a second threshold, wherein a portion of the identification result corresponding to the fifth picture matches a corresponding portion of the object to be identified.

16. The method according to claim 9, further comprising:
displaying text associated with the fifth picture in association with the fifth picture.

17. The method according to claim 9, further comprising:
highlighting the fifth pictures and/or text associated with the fifth pictures in response to the fifth pictures being operated.

18. The method according to claim 9, further comprising:
further displaying a seventh picture corresponding to the image in response to obtaining the identification result.

19. A method for displaying an identification result, comprising:
receiving an image, which is capable of presenting a first portion of an object to be identified, and identifying the first portion; and
displaying an eighth picture presenting a first portion of the identification result in response to obtaining the identification result, wherein the eighth picture further presents a second portion of the identification result that is different from the first portion.

20. The method according to claim 19, wherein the second portion presented by the eighth picture is manipulatable, and the method further comprises:
displaying a ninth picture presenting the second portion and/or text associated with the second portion in response to the second portion being operated.

21. A computer system for displaying an identification result, comprising:
a processor or a plurality of processors; and
a memory or a plurality of memories, wherein the memory or the plurality of memories are configured to store a series of computer-executable instructions and computer-accessible data associated with the series of computer-executable instructions,
wherein when the series of computer-executable instructions are executed by the processor or the plurality of processors, the processor or the plurality of processors are enabled to perform the method according to claim 1.

22. A non-transitory computer readable storage medium, wherein the non-transitory computer readable storage medium stores a series of computer-executable instructions, and when the series of computer-executable instructions are executed by a computer apparatus or a plurality of computer apparatuses, the computer apparatus or the plurality of computer apparatuses are enabled to perform the method according to claim 1.
